(19) United States
(12) Patent Application Publication
(10) Pub. No.: US 2025/0301463 A1
(43) Pub. Date: Sep. 25, 2025

(54) UE, NETWORK NODE AND METHODS FOR HANDLING CG-SDT RESOURCES

(71) Applicant: Telefonaktiebolaget LM Ericsson (publ), Stockholm (SE)

(72) Inventors: Jan Christoffersson, Lulea (SE); Stefan Wanstedt, Lulea (SE); Revathy Narayanan, Sollentuna (SE); Henrik Enbuske, Stockholm (SE); Emre Yavuk, Stockholm (SE); Andreas Hoglund, Solna (SE)

(21) Appl. No.: 18/860,526

(22) PCT Filed: Mar. 14, 2023
(86) PCT No.: PCT/SE2023/050226

§ 371 Date: Oct. 25, 2024

Related U.S. Application Data
(60) Provisional application No. 63/363,576, filed on Apr. 26, 2022.

(51) Int. Cl. H04W 72/115; H04W 74/0833

(52) U.S. Cl. CPC H04W 72/115; H04W 74/0833

(57) ABSTRACT

The present disclosure relates to a method performed by a network node (101) for handling Configured Grant-Small Data Transmissions, CG-SDT, resources in a communications system (100). The network node (101) provides a configuration for common CG-SDT resources to a User Equipment, UE (105). The common CG-SDT resources are common to multiple UEs (105). The network node (101) provides information indicating which SDT resource the UE (105) should use. The SDT resource is the common CG-SDT resources or other Mobile Originated-Small Data Transmissions, MO-SDT, resources.

### TECHNICAL FIELD

The present disclosure relates generally to a network node, a method performed by the network node, a User Equipment (UE) and a method performed by the UE. More particularly, the present disclosure relates to handling Configured Grant-Small Data Transmissions (CG-SDT) resources. The present disclosure relates to shared CG-SDT resources for Mobile Terminated-Small Data Transmissions, MT-SDT.

### BACKGROUND

In Release 15 (Rel-15), the Third Generation Partnership Project (3GPP) introduced a new radio-access technology known as New Radio (NR). The technology was further enhanced in Release 16 (Rel-16) and will continue to evolve in Release 17 (Rel-17) and later. In NR, the UE can be in Radio Resource Control (RRC) idle state, in RRC connected state or in RRC inactive state. Until Rel-16, the data transmission was possible only in RRC connected state. Therefore, the UE must be moved to a connected state from idle state or inactive state every time there is data to be transferred between the UE and network node, e.g. Next Generation Node B (gNode B, gNB). This leads to significant signaling overhead and power consumption, in particular for UEs that need infrequent transmission of small data packets. To avoid the associated signaling overhead a new approach is that the UE transmits small data packets when it is in inactive state, within which the UE has established an RRC context and a core network connection. Therefore, the transition of the UE from inactive state to connected state is relatively fast and requires less signaling, compared to the transition from idle state to connected state.

### NR Small Data Transmissions in Inactive State

Work has been performed related to NR Small Data Transmissions (NR SDT) when the UE is in inactive state with the focus of optimizing the transmission for small data payloads by reducing the signaling overhead. The work has some of the following objectives for enabling Small Data Transmission (SDT) in RRC inactive state:
For the RRC inactive state:
   Uplink (UL) SDT for Random Access Channel (RACH)-based schemes, i.e., 2-step and 4-step RACH:
      General procedure to enable User Plane (UP) data transmission for small data packets from inactive state, e.g. using message A (MSGA) or message 3 (MSG3).
      Enable flexible payload sizes larger than the Rel-16 Common Control Channel (CCCH) message size that is possible currently for inactive state for MSGA and MSG3 to support UP data transmission in the UL. The actual payload size can be up to network configuration.
      Context fetch and data forwarding with and without anchor relocation in inactive state for RACH-based solutions.
   Transmission of UL data on pre-configured Physical Uplink Shared Channel (PUSCH) resources, i.e., reusing the configured grant type 1—when the Timing Advance (TA) is valid
      General procedure for SDT over configured grant type 1 resources from inactive state
      Configuration of the configured grant type 1 resources for small data transmission in UL for inactive state

The SDT procedure in NR Rel-17 is only for Mobile Originated-SDT (MO-SDT) meaning that it is only triggered by UL data transmissions.

For Narrowband-Internet of things (NB-IoT) and Long Term Evolution Machine Type Communication (LTE-M) similar signaling optimizations for small data have been introduced through Rel-15 Early Data Transmission (EDT) and Rel-16 Preconfigured Uplink Resources (PUR). The main differences for the NR SDT solutions are that the Rel-17 NR SDT is only to be supported for RRC inactive state, includes also 2-step RACH based SDT, and that it should also include regular complexity mobile broadband (MBB) UEs. Both support MO traffic only. NR SDT also, unlike LTE EDT, supports transmission of subsequent data, that is larger payload sizes which require more than one transmission.

Random Access based-SDT (RA-SDT) means that either legacy 4-step RACH or 2-step RACH procedure is used as a baseline but that a UP data payload can be appended, multiplexed with the RRCResumeRequest message, in MSG3 or MSGA. CG-SDT means that the UEs are configured via RRC to have periodic CG-SDT occasions which can, contention-free, be used for UL transmission. In this way MSG1 and MSG2 can be omitted but it is a requirement that the UE has a valid TA and is uplink synchronized to be able to use the resources for transmission.

### Transmission of UL Data on Pre-Configured PUSCH Resources, the MO CG-SDT Procedure

The CG-SDT procedure uses Configured Grant Physical Uplink Shared Channel (CG PUSCH) resources that are PUSCH resources configured in advance for the UE. When there is uplink data available at the UE's buffer or data storage, it can immediately start UL transmission using the pre-configured PUSCH resources without waiting for an UL grant from the network node, e.g., gNB, thus reducing the latency. NR supports CG type 1 PUSCH transmission and CG type 2 PUSCH transmission. For both two types, the PUSCH resources, e.g. time and frequency allocation, periodicity, etc., are preconfigured via dedicated RRC signaling. The CG type 1 PUSCH transmission is activated and deactivated by RRC signaling, while the CG type 2 PUSCH transmission is activated and deactivated by an UL grant using Downlink Control Information (DCI) signaling. The CG type 1 is used for SDT.

The CG-SDT configuration will be sent to the UE in the RRCRelease message and will specify associations between CG resources, e.g. transmission opportunities, and Synchronization Signal Blocks (SSB). The UE will upon initiating the CG-SDT procedure select an SSB with Synchronization Signal-Reference Signal Received Power (SS-RSRP) above a configured RSRP threshold. The initial CG-SDT transmission will contain the RRCResumeRequest multiplexed with data and possibly a Buffer Status Report Medium Access Control Control Element (BSR MAC CE) and possibly a Power Headroom Report Medium Access Control Control Element (PHR MAC CE). If the gNB receives the transmission successfully it will reply with dynamic scheduling of a new uplink transmission for the same Hybrid Automatic Repeat Request (HARQ) process as acknowledgement or possibly with a Downlink (DL) data transmission. After this the UE may use the following CG-SDT resources for transmission of new UL data after successful Timing Advance (TA) validation and SSB selection. The TA validation means that the CG-SDT TA timer is running and the change of the SS-RSRP(s) are within configured thresholds. The CG-SDT procedure is terminated when the CG-SDT-TA timer expires, the UE reselects to a different cell or the gNB sends a RRCResume or RRCRelease to the UE.

For LTE support for Mobile Terminated (MT) traffic was introduced later in Rel-16, that is supporting transmissions of small data payloads in the downlink.

NR MT-SDT is being introduced in Rel-18. Work related to MT-SDT work comprises the following objectives:
Specify the support for paging-triggered SDT, e.g., MT-SDT
   MT-SDT triggering mechanism for UEs in RRC inactive, supporting RA-SDT and CG-SDT as the UL response;
   MT-SDT procedure for initial DL data reception and subsequent UL/DL data transmissions in RRC inactive.

The exact procedure is to be defined, but a probable baseline can be expected to be as follows:
1. DL data triggers an MT-SDT procedure in the network.
2. The network pages the UE.
3. The UE responds to the paging by initiating an SDT procedure, either CG-SDT or RA-SDT. This means that the UE sends an RRCResumeRequest message.
4. The network, after contention resolution in case of RA-SDT, schedules a DL transmission including the data that triggered the MT-SDT procedure.
5. The UE may optionally acknowledge the DL transmission.
6. The network either moves the UE to connected mode or releases the UE to idle or inactive mode.

An example of baseline procedures for RA-SDT is shown in FIG. 1 and for CG-SDT in FIG. 2. FIG. 1 illustrates MT-SDT using a RA-SDT procedure where the UE triggers RA-SDT upon reception of paging. FIG. 2 illustrates MT-SDT using CG-SDT where the UE triggers CG-SDT upon reception of paging.

A drawback with CG-SDT is that resources are statically assigned to a UE and these resources may be unused for a long time in case the UE does not have any data to transmit. Since the resources are dedicated to a single UE, the resources cannot be used by the network node, e.g., gNB, to schedule a dynamic transmission for another UE since this could lead to collisions. In MO-SDT, it is not possible to configure the same resources to several different UEs without this leading to collisions between different UEs.

The MT-SDT triggering mechanism for UEs in RRC inactive supports RA-SDT and CG-SDT as the UL response, but as mentioned above, and due to the fact that it is highly inefficient to configure CG-SDT resources for a UE just in case it would later obtain MT-SDT data, the CG-SDT response is not very well suited without any modification or improvement to better suit MT-SDT.

Therefore, there is a need to at least mitigate or solve this issue.

### SUMMARY

An object of the present disclosure is to obviate at least one of the above disadvantages and to improve handling of CG-SDT resources in a communications system.

According to a first aspect, the object is achieved by a method performed by a network node for handling CG-SDT resources in a communications system. The network node provides a configuration for common CG-SDT resources to a UE. The common CG-SDT resources are common to multiple UEs. The network node provides, to the UE, information indicating which SDT resource the UE should use. The SDT resource is the common CG-SDT resources or other MO-SDT resources.

According to a second aspect, the object is achieved by a method performed by a UE for handling CG-SDT resources in a communications system. The UE obtains a configuration for common CG-SDT resources from a network node. The common CG-SDT resources are common to multiple UEs. The UE obtains, from the network node, information indicating which SDT resource the UE should use. The SDT resource is the common CG-SDT resources or other MO-SDT resources. The UE initiates a SDT procedure by using the common CG-SDT resources or the other MO-SDT resources, according to the obtained information.

According to a third aspect, the object is achieved by a network node for handling CG-SDT resources. The network node is arranged to perform a method according to the first aspect.

According to a fourth aspect, the object is achieved by a UE for handling CG-SDT resources. The UE is arranged to perform a method according to the second aspect.

Thanks to the configuration of common CG-SDT resources, the same or common CG-SDT resources can be configured to several UEs in the case of MT-SDT without leading to collisions. Thus, the handling of CG-SDT resources in a communications system is improved.

The present disclosure herein affords many advantages, of which a non-exhaustive list of examples follows:

An advantage of the embodiments herein may be that there is less overhead in terms of reserved CG-SDT resources. This is of particular importance in the case of MT-SDT since it may be very infrequent data in DL and the maximum periodicity of CG-SDT resources is only 640 ms in Rel 17.

A further advantage of the embodiments herein may be that, if the CG-SDT resources are configured in system information, the procedure can also be used for UEs that have reselected to new cells.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be described in more detail by way of example only in the following detailed description by reference to the appended drawings in which:

FIG. 1 is a schematic drawing illustrating a procedure for RA-SDT.

FIG. 2 is a schematic drawing illustrating a procedure for CG-SDT.

FIG. 3 is a schematic drawing illustrating a communications system.

FIG. 4 is a signaling diagram illustrating a method.

FIG. 5 is a flow chart illustrating a method performed by a network node.

FIG. 6 is a flow chart illustrating a method performed by a UE.

FIG. 7a is a schematic drawing illustrating a UE.

FIG. 7b is a schematic drawing illustrating a UE.

FIG. 8a is a schematic drawing illustrating a network node.

FIG. 8b is a schematic drawing illustrating a network node.

FIG. 9 is a schematic block diagram illustrating a telecommunication network connected via an intermediate network to a host computer.

FIG. 10 is a schematic block diagram of a host computer communicating via a network node with a UE over a partially wireless connection.

FIG. 11 is a flowchart depicting a method in a communications system comprising a host computer, a network node and a UE.

FIG. 12 is a flowchart depicting a method in a communications system comprising a host computer, a network node and a UE.

FIG. 13 is a flowchart depicting a method in a communications system comprising a host computer, a network node and a UE.

FIG. 14 is a flowchart depicting a method in a communications system comprising a host computer, a network node and a UE.

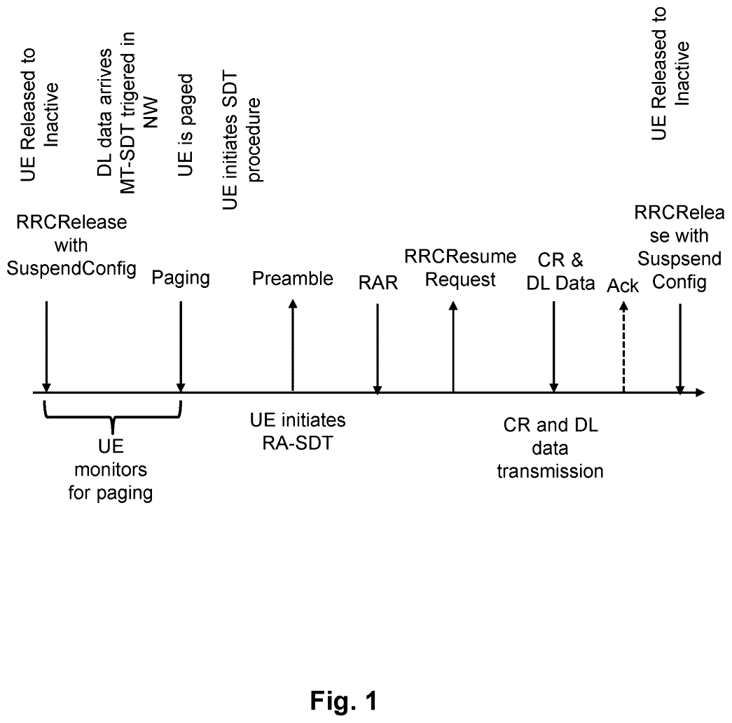

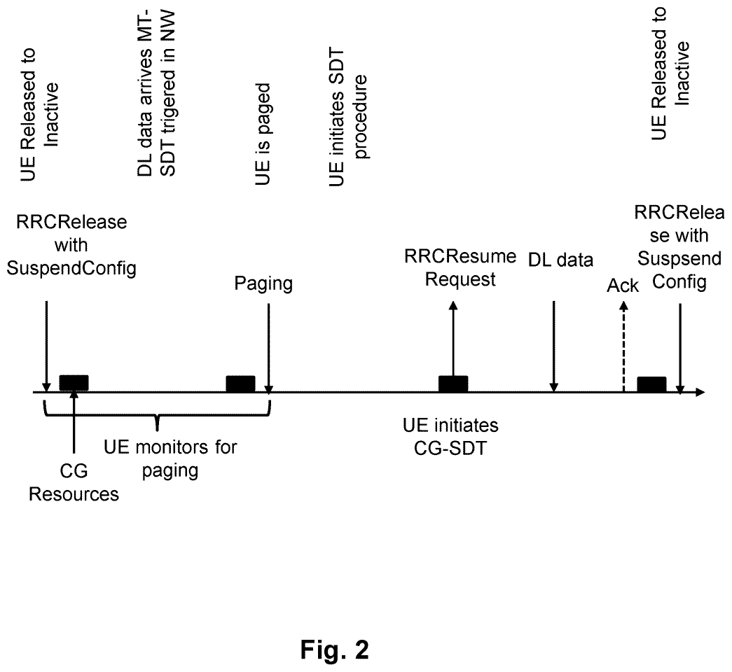

The drawings are not necessarily to scale, and the dimensions of certain features may have been exaggerated for the sake of clarity. Emphasis is instead placed upon illustrating the principle.

### DETAILED DESCRIPTION

The present embodiments relate to how the same or common CG-SDT resources may be configured by a network node to several UEs in the case of MT-SDT without leading to collisions. The network node may configure the resources in System Information (SI) and indicate in the paging message if the common CG-SDT resources should be used or if the UE should use other MO-SDT resources such as dedicated CG-SDT or RA-SDT resources. SDT may be used as an example herein, and the present disclosure may be equally related to EDT, data transmission of data having a size below a threshold, data being of a particular type, or some other type of data.

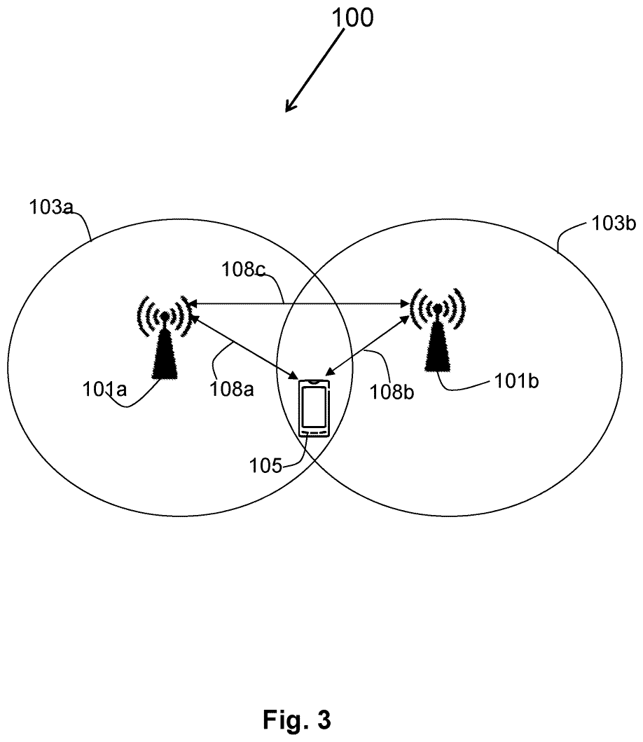

FIG. 3 depicts a non-limiting example of a communications system 100, which may be a wireless communications system, sometimes also referred to as a wireless communications network, cellular radio system, or cellular network, in which the present disclosure may be implemented. The communications system 100 may be a Fifth Generation (5G) system, 5G network, NR-U or Next Gen system or network. The communications system 100 may alternatively be a younger system or older system than a 5G system, such as e.g. a Second Generation (2G) system, a Third Generation (3G) system, a Fourth Generation (4G) system, a Sixth Generation (6G) system, a Seventh Generation (7G) system etc. The communications system 100 may support other technologies such as, for example, Long-Term Evolution (LTE), LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, NB-IoT. Thus, although terminology from 5G, NR and LTE may be used in this disclosure to exemplify, this should not be seen as limiting to only the aforementioned systems.

The communications system 100 comprises one or a plurality of network nodes, whereof a first network node 101a and a second network node 101b are depicted in the non- limiting example of FIG. 3. Any of the first network node 101a, and the second network node 101b may be a radio network node, such as a radio base station, or any other network node with similar features capable of serving a user equipment, such as a wireless device or a machine type communication device, in the communications system 100. The first network node 101a may be an evolved Node B (eNB) and the second network node 101b may be a gNB. The first network node 101a may be a first eNB, and the second network node 101b may be a second eNB. The first network node 101a may be a first gNB, and the second network node 101b may be a second gNB. The first network node 101a may be a Master eNB (MeNB) and the second network node 101b may be a gNB. Any of the first network node 101a and the second network node 101b may be co-localized, or they may be part of the same network node. The first network node 101a may be referred to as a source node or source network node, whereas the second network node 101b may be referred to as a target node or target network node. When the reference number 101 is used herein without the letters a or b, it refers to a network node in general, i.e. it refers to any of the first network node 101a or second network node 101b.

The communications system 100 covers a geographical area which may be divided into cell areas. Each cell area may be served by a network node, although, one network node may serve one or several cells. In FIG. 3, the communications system 100 comprises a first cell 103a and a second cell 103b. Note that two cells are illustrated in FIG. 3 only as an example, and that any n number of cells may be comprised in the communication system 100, where n is any positive integer. A cell is a geographical area where radio coverage is provided by the network node at a network node site. Each cell is identified by an identity within the local network node area, which is broadcast in the cell. In FIG. 3, first network node 101a serves the first cell 103a, and the second network node 101b serves the second cell 103b. Any of the first network node 101a and the second network node 101b may be of different classes, such as, e.g., macro base station (BS), home BS or pico BS, based on transmission power and thereby also cell size. Any of the first network node 101a and the second network node 101b may be directly connected to one or more core networks, which are not depicted in FIG. 3 for the sake of simplicity. Any of the first network node 101a and the second network node 101n may be a distributed node, such as a virtual node in the cloud, and it may perform its functions entirely on the cloud, or partially, in collaboration with another network node. The first cell 103a may be referred to as a source cell, whereas the second cell 103b may be referred to as a target cell. When the reference number 103 is used herein without the letters a or b, it refers to a cell in general, i.e., it refers to any of the first cell 103a or second cell 103b.

One or a plurality of UEs 105 is comprised in the communication system 100. Only one UE 105 is exemplified in FIG. 3 for the sake of simplicity. A UE 105 may also be referred to simply as a device. The UE 105, e.g. an LTE UE or a 5G/NR UE, may be a wireless communication device which may also be known as e.g., a wireless device, a mobile terminal, wireless terminal and/or mobile station, a mobile telephone, cellular telephone, or laptop with wireless capability, just to mention some examples. The UE 105 may be a device by which a subscriber may access services offered by an operator's network and services outside the operator's network to which the operator's radio access network and core network provide access, e.g., access to the Internet. The UE 105 may be any device, mobile or stationary, enabled to communicate over a radio channel in the communications system 100, for instance but not limited to e.g. UE, mobile phone, smart phone, sensors, meters, vehicles, household appliances, medical appliances, media players, cameras, Machine to Machine (M2M) device, IoT device, terminal device, communication device or any type of consumer electronic, for instance but not limited to television, radio, lighting arrangements, tablet computer, laptop or Personal Computer (PC). The UE 105 may be portable, pocket storable, hand held, computer comprised, or a vehicle mounted device, enabled to communicate voice and/or data, via the radio access network, with another entity, such as another UE, a server, a laptop, a Personal Digital Assistant (PDA), or a tablet, Machine-to-Machine (M2M) device, a device equipped with a wireless interface, such as a printer or a file storage device, modem, or any other radio network unit capable of communicating over a radio link in the communications system 100.

The UE 105 is enabled to communicate wirelessly within the communications system 100. The communication may be performed e.g., between two UEs 105, between a UE 105 and a regular telephone, between the UE 105 and a network node 101, between network nodes 101, and/or between the UE 105 and a server via the radio access network and possibly one or more core networks and possibly the internet.

The first network node 101a may be configured to communicate in the communications system 100 with the UE 105 over a first communication link 108a, e.g., a radio link. The second network node 101b may be configured to communicate in the communications system 100 with the UE 105 over a second communication link 108b, e.g., a radio link. The first network node 101a may be configured to communicate in the communications system 100 with the second network node 101b over a third communication link 108c, e.g., a radio link or a wired link, although communication over more links may be possible. When the reference number 108 is used herein without the letters a, b or c, it refers to a communication link in general, i.e. it refers to any of the first communication link 108a, the second communication link 108b and the third communication link 108c.

It should be noted that the communication links 108 in the communications system 100 may be of any suitable kind comprising either a wired or wireless link. The link may use any suitable protocol depending on type and level of layer, e.g. as indicated by the Open Systems Interconnection (OSI) model, as understood by the person skilled in the art.

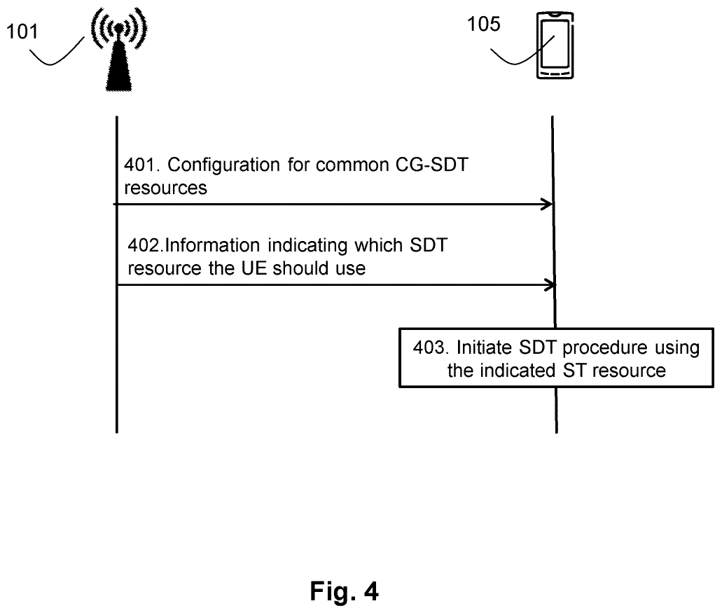

The method for herein will now be described with reference to the signaling diagram depicted in FIG. 4. The method comprises at least one of the following steps, which steps may as well be carried out in another suitable order than described below:

### Step 401

The network node 101 provides a configuration for common CG-SDT resources to the UE 105. The UE 105 obtains, from the network node 101, the configuration for common CG-SDT resources. The common CG-SDT resource are common to multiple UEs 105, i.e., two or more UEs 105. The common CG-SDT resources may be referred to as a shared CG-SDT resource.

The configuration for common CG-SDT resource may be provided to multiple UEs 105, i.e., to two or more UEs 105. The UEs 105 may be in a group of UEs 105, for example a group determined by the network node 101.

### Step 402

The network node 101 provides, to the UE 105, information indicating which SDT resource the UE 105 should use. The UE 105 obtains, from the network node 101, the information indicating which SDT resource the UE 105 should use.

The information may be provided to multiple UEs 105, i.e., to two or more UEs 105. The UEs 105 may be in a group of UEs 105, for example a group determined by the network node 101.

### Step 403

The UE 105 initiates SDT procedure using the indicated SDT resource from step 402.

Some more details of the steps above will now be provided.

In a first step, which may correspond to step 401 in FIG. 4, common CG-SDT resources are configured for UEs 105 to use to trigger a SDT procedure by any of the following methods:
Several UEs 105 receive the same configuration in their respective RRCRelease messages, the configuration may only be valid within the cell 103 where the UE 105 received the RRCRelease.
Common resources are configured in SI. This configuration could optionally be reserved only for MT-SDT.
A combination of the above, i.e., a UE 105 is configured with one, possibly shared CG-SDT configuration in RRCRelease which may be valid only within the cell where the UE 105 received the RRCRelease and at the same time there is an additional CG-SDT from SI which the UE 105 may use.

In both cases, the configurations may comprise different Demodulation Reference Signal (DMRS) resources. This means that for the same time and frequency allocation, transmissions may be distinguishable by the network node 101 depending on which DMRS resources that was used for the transmission. In this way, two UEs 105 may transmit on the same time and frequency resource using different DMRS resources, and the network node 101 may still detect and decode both transmissions. The network node 101 may indicate the DMRS resource which should be applied by the UE 105 in the paging message, in addition to the MT-SDT indication. This may allow for UE multiplexing of MT-SDT since the UEs 105 could respond simultaneously in the UL. In one option herein, the network node 101 indication reference to an alternative SSB to PUSCH mapping configuration for which the UE(s) 105 may have previously been configured in RRCRelease message or in an otherwise dedicated configuration while in RRC connected.

As a further option, it may be indicated in the CG-SDT configuration provided in an RRCRelease message whether it is shared or not. In an option herein, the UE 105 may, because of this indication, not perform a random selection of the DMRS port to be used, or alternatively the UE 105 may limit the selection to a subset or single DMRS port.

There may be a time limit for how long the UE 105 may use the indicated resource. For example, if no acknowledgement is received to the RRCResumeRequest, the UE 105 may initiate a re-transmission on the indicated CG-SDT resource. However, this may only be done during the indicated time limit. Alternatively, the time limit may refer only to, or additionally new transmissions for the use of periodical CG-SDT occasions containing subsequent (new) data. This time period may be implemented as a timer which is started when the paging is received or at the first transmission on the indicated CG-SDT resource. Alternatively, a number N of CG-SDT resources during which the UE 105 is allowed to send the response in UL may be configured or pre-defined. E.g. if N=2 is configured, the UE 105 can transmit, or retransmit the UL response to MT-SDT in the two CG-SDT resources subsequent to the MT-SDT transmission but not in any other.

The UE 105 may receive, from the network node 101, a dedicated configuration regarding when it is allowed to transmit the response to the data received in the DL, i.e., MT-SDT, as part of the RRCRelease message that delivers the MT-SDT transmission. The DL may be described as a link going from the network node 101 to the UE 105. An UL may be described as a link going from the UE 105 to the network node 101, i.e., in the opposite direction of the DL. The dedicated configuration provides a value to setup a timer which should be started when the RRCRelease message is received. When the timer is running, the UE 105 may not be allowed to respond, i.e., acknowledge the data received via MT-SDT transmission, using any of the UL transmission occasions configured for shared CG-SDT. When the timer is running, UL transmission CG-SDT occasions that overlap with the running timer may be masked for transmission for that UE 105. The timer may either be set up with a time value or the number of upcoming CG-SDT uplink transmission occasions. The value range to set up the timer can have any value including zero. The intention may be to provide means to configure dedicated offset values for UEs 105 that are likely to have collisions when using shared CG-SDT occasions for UL transmission to acknowledge the reception of MT-SDT. In another option, the timer, mentioned above may be configured, e.g., by the network node 101, so that the UE 105 may be allowed to transmit in the UL using the CG-SDT occasions while the timer is running, however the timer can be started with an offset value, which is configured per UE 105.

The network node 101 may group the UEs 105 based on their distance from the network node 101 using parameters like TA and allocate a common CG resource between them. Grouping UEs 105 based on TA and sharing a common CG resource among them allows configuring the re-transmission timers in accordance with the TA. Assuming that the UEs 105 closer to the network node 101 might have better channel conditions and therefore better chances for successful transmission on an average compared to UEs 105 which are far from the network node 101, UE groups with smaller TAs can be configured with a shorter re-transmission timer while UEs 105 with a longer TA can be provided with a larger re-transmission timer. Alternatively, the network node 101 may use a different number of max number of retransmissions, e.g. autonomously, performed by UEs 105 following the initial CG-SDT transmission using the periodic UL CD-SDT resource configuration. The network node 101 may also configure CG-SDT resources depending on the TA so that UEs 105 with a small TA shares CG-SDT resources configured with larger Transport Block (TB) than for UE groups with large TA.

The CG-SDT resources may be used without considering if the legacy TA validity is fulfilled, i.e., even when the SS-RSRP has changed more than a threshold. This may be indicated in the configuration given in SI and also specify that a TA=0 is used. This may be configured for small cells where a TA of 0 is sufficient.

In a second step, which may correspond to step 402 in FIG. 4 the network node 101 may indicate in, e.g., in the paging message, which CG-SDT resource the UE 105 should use. The indication is needed in order to ensure that two different UEs 105 do not collide by transmitting on the same CG-SDT resource, including the same DMRS-port. The indication may further:
Initiate MO-SDT by transmitting the RRCResumeRequest on the CG-SDT resource configured in SI.
   In one option, a specific DMRS-resource may be indicated.
Initiate MO-SDT by transmitting the RRCResumeRequest on the shared CG-SDT resource configured by RRCRelease message.
Include a timer value for how long the UE 105 may use the indicated CG-SDT resource, or counter, see above.

The CG-SDT resource may be indicated by using the configuration index for the CG-SDT configuration in SI or in RRCRelease message.

To avoid collisions, the network node 101 may only indicate any single CG-SDT configuration to one single UE 105. The other UEs 105 may do RA-SDT upon receiving a paging for MT-SDT or possibly CG-SDT on a dedicated CG-SDT configuration.

In one embodiment, which gives the possibility for collisions, several or all UEs 105 may use the shared CG-SDT. The possibility for collisions may be allowed at e.g., low load, either as the number of connected UEs 105 or based on the position, i.e., when the UE 105 is in an area with very few other devices, or when the UEs 105 are moving slowly or not at all, low mobility or stationary. In this case, it may be specified that only one specific UE 105 may be allowed to retransmit the initial CG transmission, containing the RRCResumeRequest, in case no acknowledgement is received. Note that in this case there may be still no need for contention resolution procedure since it from the UE_ID, i.e. Inactive-Radio Network Temporary Identifier, I-RNTI, in RRCResumeRequest would be clear which MT-SDT is being acknowledged.

The other UEs 105 which do not receive a response to the RRCResumeRequest due to collision, i.e., no DL data is received after sending the RRCResumeRequest, may back off and retransmit after a random time, or use a subsequent CG-SDT transmission occasion to re-transmit the RRCResumeRequest, or fall back to RA-SDT transmission of the RRCResumeRequest message.

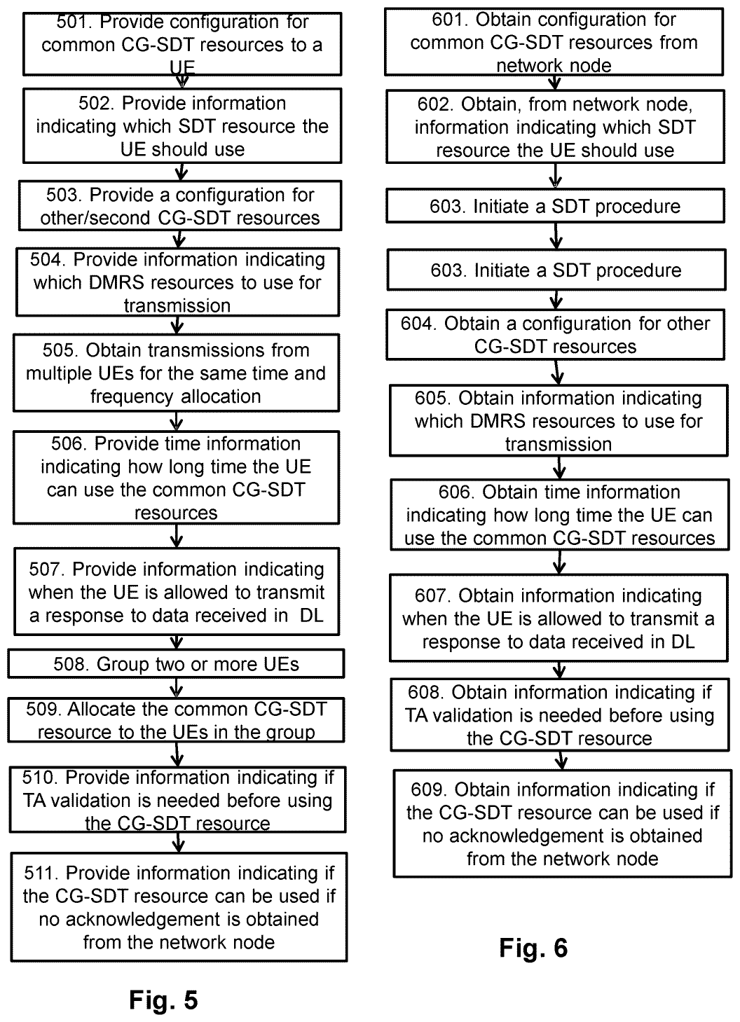

The method described above will now be described seen from the perspective of the network node 101. FIG. 5 is a flowchart describing the present method in the network node 101 for handling CG-SDT resources in a communications system 100. The method comprises at least one of the following steps to be performed by the network node 101, which steps may be performed in any suitable order than described below:

### Step 501

This step corresponds to step 401 in FIG. 4. The network node 101 provides a configuration for common CG-SDT resources to a UE 105. The common CG-SDT resources are common to multiple UEs 105. The network node 101 may provide the configuration for common CG-SDT resources to multiple UEs 105.

The configuration for common CG-SDT resources may be comprised in SI.

The configuration for common CG-SDT resources may be comprised in a RRC Release message.

The configuration for common CG-SDT resources may comprise an indication of whether the common CG-SDT resource is shared or not.

### Step 502

The network node 101 provides, to the UE 105, information indicating which SDT resource the UE 105 should use. The SDT resource is the common CG-SDT resources or other MO-SDT resources. The network node 101 may provide the information to multiple UEs 105.

The other MO-SDT resources may comprise dedicated CG-SDT resources or RA-SDT resources.

The information indicating if the common CG-SDT resources should be used or if the UE should use other MO-SDT resources may be comprised in a paging message.

### Step 503

The network node 101 may provide, to the UE 105, a configuration for other CG-SDT resources. The other CG-SDT resources may be referred to as second CG-SDT resources. The network node 101 may provide the configuration to multiple UEs 105.

### Step 504

The network node 101 may provide, to the UE 105, information indicating which DMRS resources to use for transmission. The UE 105 may use different DMRS resources than other UEs 105. The network node 101 may provide the information to multiple UEs 105.

### Step 505

The network node 101 may obtain transmissions from multiple UEs 105 for the same time and frequency allocation. The multiple transmissions may be distinguishable by the network node 101 by that they use different DMRS resources. The multiple UEs 105 may be comprised in a group.

### Step 506

The network node 101 may provide, to the UE 105, time information indicating how long time the UE 105 can use the common CG-SDT resources. The network node 101 may provide the time information to multiple UEs 105. The time information may be the same for all UEs 105 or it may be different for one or more UEs 105 in the multiple UEs 105.

### Step 507

The network node 101 may provide, to the UE 105, information indicating when the UE 105 is allowed to transmit a response to data received in a DL. The network node 101 may provide the information to multiple UEs 105.

### Step 508

The network node 101 may group two or more UEs 105 based on their distance from the network node 101.

### Step 509 The network node 101 may allocate the common CG-SDT resource to the UEs 105 in the group. The configuration for the common CG-SDT resources may be provided to all UEs 105 in the group.

### Step 510

The network node 101 may provide, to the UE 105, information indicating if TA validation is needed before using the CG-SDT resource. The network node 101 may provide the information to multiple UEs 105.

### Step 511

The network node 101 may provide, to the UE 105, information indicating if the CG-SDT resource can be used if no acknowledgement is obtained from the network node 101. The network node 101 may provide the information to multiple UEs 105.

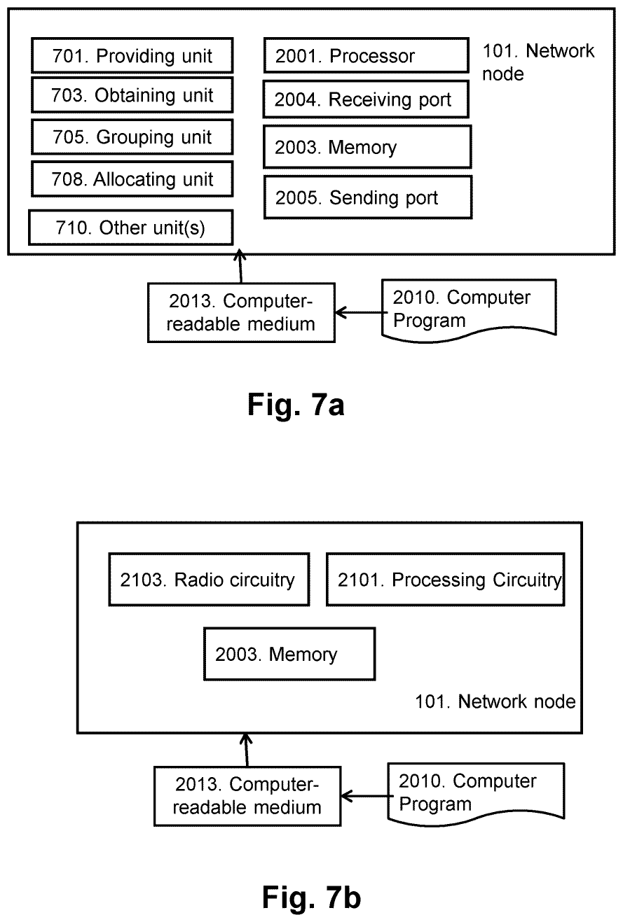

To perform the method steps shown in FIG. 5 for handling CG-SDT resources in a communications system the network node 101 comprises an arrangement as shown in FIG. 7a and/or FIG. 7b. FIGS. 7a and FIG. 7b depict two different examples in panels a) and b), respectively, of the arrangement that the network node 101 may comprise. The network node 101 may comprise the following arrangement depicted in FIG. 7a.

The network node 101 is arranged to, e.g., by means of a providing unit 701, provide a configuration for common CG-SDT resources to a UE 105. The network node 101 may be arranged to provide the configuration to multiple UEs 105. The common CG-SDT resources are common to multiple UEs 105. The configuration for common CG-SDT resources may be comprised in SI. The configuration for common CG-SDT resources may be comprised in a RRC Release message. The configuration for common CG-SDT resources may comprise an indication of whether the common CG-SDT resource is shared or not. The configuration for common CG-SDT resources may be provided to multiple UEs 105. The providing unit 701 may also be referred to as a providing module, a providing means, a providing circuit, means for providing etc. The providing unit 701 may be a processor 2001 of the network node 101 or comprised in the processor 2001 of the network node 101.

The network node 101 is arranged to, e.g., by means of the providing unit 701, provide, to the UE 105, information indicating which SDT resource the UE 105 should use. The SDT resource is the common CG-SDT resources or other MO-SDT resources. The network node 101 may be arranged to provide the information to multiple UEs 105.

The other MO-SDT resources may comprise dedicated CG-SDT resources or RA-SDT resources.

The information indicating if the common CG-SDT resources should be used or if the UE 105 should use other MO-SDT resources may be comprised in a paging message.

The network node 101 may be arranged to, e.g., by means of the providing unit 701, provide, to the UE 105, a configuration for other CG-SDT resources. The other CG-SDT resources may be referred to as second CG-SDT resources. The network node 101 may be arranged to provide the configuration to multiple UEs 105.

The network node 101 may be arranged to, e.g., by means of the providing unit 701 provide, to the UE 105, information indicating which DMRS resources to use for transmission. The UE 105 may use different DMRS resources than other UEs 105. The network node 101 may be arranged to provide the information to multiple UEs 105.

The network node 101 may be arranged to, e.g., by means of an obtaining unit 703, obtain transmissions from multiple UEs 105 for the same time and frequency allocation. The multiple transmissions may be distinguishable by the network node 101 by that they use different DMRS resources. The obtaining unit 703 may also be referred to as an obtaining module, an obtaining means, an obtaining circuit, means for obtaining etc. The obtaining unit 703 may be the processor 2001 of the network node 101 or comprised in the processor 2001 of the network node 101.

The network node 101 may be arranged to, e.g., by means of the providing unit 701 provide, to the UE 105, time information indicating how long time the UE 105 can use the common CG-SDT resources. The network node 101 may be arranged to provide the time information to multiple UEs 105.

The network node 101 may be arranged to, e.g., by means of the providing unit 701 provide, to the UE 105, information indicating when the UE 105 is allowed to transmit a response to data received in a DL. The network node 101 may be arranged to provide the information to multiple UEs 105.

The network node 101 may be arranged to, e.g., by means of a grouping unit 705, group two or more UEs 105 based on their distance from the network node 101. The grouping unit 705 may also be referred to as a grouping module, a grouping means, a grouping circuit, means for grouping etc. The grouping unit 705 may be the processor 2001 of the network node 101 or comprised in the processor 2001 of the network node 101.

The network node 101 may be arranged to, e.g., by means of an allocating unit 708, allocate the common CG-SDT resource to the UEs 105 in the group. The configuration for the common CG-SDT resources may be provided to all UEs 105 in the group. The allocating unit 708 may also be referred to as an allocating module, an allocating means, an allocating circuit, means for allocating etc. The allocating unit 708 may be the processor 2001 of the network node 101 or comprised in the processor 2001 of the network node 101.

The network node 101 may be arranged to, e.g., by means of the providing unit 701 provide, to the UE 105, information indicating if TA validation is needed before using the CG-SDT resource. The network node 101 may be arranged to provide the information to multiple UEs 105.

The network node 101 may be arranged to, e.g., by means of the providing unit 701 provide, to the UE 105, information indicating if the CG-SDT resource can be used if no acknowledgement is obtained from the network node 101. The network node 101 may be arranged to provide the information to multiple UEs.

The present mechanism for handling CG-SDT resources in a communications system may be implemented through one or more processors, such as the processor 2001 in the network node arrangement depicted in FIG. 7a and/or 7b, together with computer program code for performing the functions described herein. The processor may be for example a Digital Signal Processor (DSP), Application Specific Integrated Circuit (ASIC) processor, Field-programmable gate array (FPGA) processor or microprocessor. The program code mentioned above may also be provided as a computer program product, for instance in the form of a data carrier carrying computer program code for performing the present disclosure herein when being loaded into the network node 101. One such carrier may be in the form of a CD ROM disc. It is however feasible with other data carriers such as a memory stick. The computer program code can be provided as pure program code on a server and downloaded to the network node 101.

The network node 101 may comprise a memory 2003 comprising one or more memory units. The memory 2003 is arranged to be used to store obtained information, store data, configurations, schedulings, and applications etc. to perform the methods herein when being executed in the network node 101.

The network node 101 may receive information from, e.g., the UE 105, through a receiving port 2004. The receiving port 2004 may be, for example, connected to one or more antennas in network node 101. The network node 101 may receive information from another structure in the communications system 100 through the receiving port 2004. Since the receiving port 2004 may be in communication with the processor 2001, the receiving port 2004 may then send the received information to the processor 2001. The receiving port 2004 may also be configured to receive other information.

The processor 2001 in the network node 101 may be configured to transmit or send information to e.g., the UE 105, or another structure in the communications system 100, through a sending port 2005, which may be in communication with the processor 2001, and the memory 2003.

The network node 101 may comprise the providing unit 701, the obtaining unit 703, the grouping unit 705, the allocating unit 708 and other unit(s) 710. Those skilled in the art will also appreciate that the providing unit 701, the obtaining unit 703, the grouping unit 705, the allocating unit 708 and other unit(s) 710 etc. described above may refer to a combination of analog and digital circuits, and/or one or more processors configured with software and/or firmware, e.g., stored in the memory 2003, that, when executed by the one or more processors such as the processor 2001, perform as described above. One or more of these processors, as well as the other digital hardware, may be comprised in a single ASIC, or several processors and various digital hardware may be distributed among several separate components, whether individually packaged or assembled into a System-on-a-Chip (SoC).

Also, the different units 701-710 described above may be implemented as one or more applications running on one or more processors such as the processor 2001.

Thus, the methods described herein for the network node 101 may be respectively implemented by means of a computer program 2010 product, comprising instructions, i.e., software code portions, which, when executed on at least one processor 2001, cause the at least one processor 2001 to carry out the actions described herein, as performed by the network node 101. The computer program 2010 product may be stored on a computer-readable storage medium 2013. The computer-readable storage medium 2013, having stored thereon the computer program 2010, may comprise instructions which, when executed on at least one processor 2001, cause the at least one processor 2001 to carry out the actions described herein, as performed by the network node 101. The computer-readable storage medium 2013 may be a non-transitory computer-readable storage medium, such as a CD ROM disc, or a memory stick. The computer program 2010 product may be stored on a carrier containing the computer program 2010 just described, wherein the carrier is one of an electronic signal, optical signal, radio signal, or the second computer-readable storage medium 2013, as described above.

The network node 101 may comprise a communication interface configured to facilitate communications between the network node 101 and other nodes or devices, e.g., the UE 105, or another structure. The interface may, for example, comprise a transceiver configured to transmit and receive radio signals over an air interface in accordance with a suitable standard.

The network node 101 may comprise the following arrangement depicted in FIG. 7b. The network node 101 may comprise a processing circuitry 2101, e.g., one or more processors such as the processor 2001, in the network node 101 and the memory 2003. The network node 101 may also comprise a radio circuitry 2103, which may comprise e.g., the receiving port 2004 and the sending port 2005. The processing circuitry 2101 may be configured to, or operable to, perform the method actions according to FIG. 4-6 in a similar manner as that described in relation to FIG. 7a. The radio circuitry 2103 may be configured to set up and maintain at least a wireless connection with the network node 101. Circuitry may be understood herein as a hardware component.

The network node 101 may be operative to operate in the communications system 100. The network node 101 may comprise the processing circuitry 2101 and the memory 2003. The memory 2003 comprises instructions executable by the processing circuitry 2101. The network node 101 is operative to perform the actions described herein in relation to the network node 101, e.g., in FIGS. 4-6.

The method described above will now be described seen from the perspective of the UE 105. FIG. 6 is a flowchart describing the present method in the UE 105 for handling CG-SDT resources in a communications system 100. The method comprises at least one of the following steps to be performed by the UE 105, which steps may be performed in any suitable order than described below:

### Step 601

This step corresponds to step 401 in FIG. 4. The UE 105 obtains a configuration for common CG-SDT resources from a network node 101. The common CG-SDT resources are common to multiple UEs 105. The UE 105 which obtains the configuration for common CG-SDT resources may be one of multiple UEs 105 that obtains the configuration for common CG-SDT resources from the network node 101.

The configuration for common CG-SDT resources may be comprised in SI.

The configuration for common CG-SDT resources may be comprised in a RRC Release message.

The configuration for common CG-SDT resources may comprise an indication of whether the common CG-SDT resource is shared or not.

### Step 602

This step corresponds to step 402 in FIG. 4. The UE 105 obtains, from the network node 101, information indicating which SDT resource the UE 105 should use. The SDT resource is the common CG-SDT resources or other MO-SDT resources. The UE 105 which obtains the information may be one of multiple UEs 105 that obtains the information from the network node 101.

The other MO-SDT resources may comprise dedicated CG-SDT resources or RA-SDT resources.

The information indicating if the common CG-SDT resources should be used or if the UE 105 should use other MO-SDT resources may be comprised in a paging message.

### Step 603

This step corresponds to step 403 in FIG. 4. The UE 105 initiates a SDT procedure by using the common CG-SDT resources or the other MO-SDT resources, according to the obtained information.

### Step 604

The UE 105 may obtain, from the network node 101, a configuration for other CG-SDT resources. The UE 105 which obtains the configuration may be one of multiple UEs 105 that obtains the configuration from the network node 101.

### Step 605

The UE 105 may obtain, from the network node 101, information indicating which DMRS resources to use for transmission. The UE 105 may use different DMRS resources than other UEs 105. The UE 105 which obtains the information may be one of multiple UEs 105 that obtains the information from the network node 101.

### Step 606

The UE 105 may obtain, from the network node 101, time information indicating how long time the UE 105 can use the common CG-SDT resources. The UE 105 which obtains the time information may be one of multiple UEs 105 that obtains the time information from the network node 101.

### Step 607

The UE 105 may obtain, from the network node 101, information indicating when the UE 105 is allowed to transmit a response to data received in a DL. The UE 105 which obtains the information may be one of multiple UEs 105 that obtains the information from the network node 101.

### Step 608

The UE 105 may obtain, from the network node 101, information indicating if TA validation is needed before using the CG-SDT resource. The UE 105 which obtains the information may be one of multiple UEs 105 that obtains the information from the network node 101.

### Step 609

The UE 105 may obtain, from the network node 101, information indicating if the CG-SDT resource can be used if no acknowledgement is obtained from the network node 101. The UE 105 which obtains the information may be one of multiple UEs 105 that obtains the information from the network node 101.

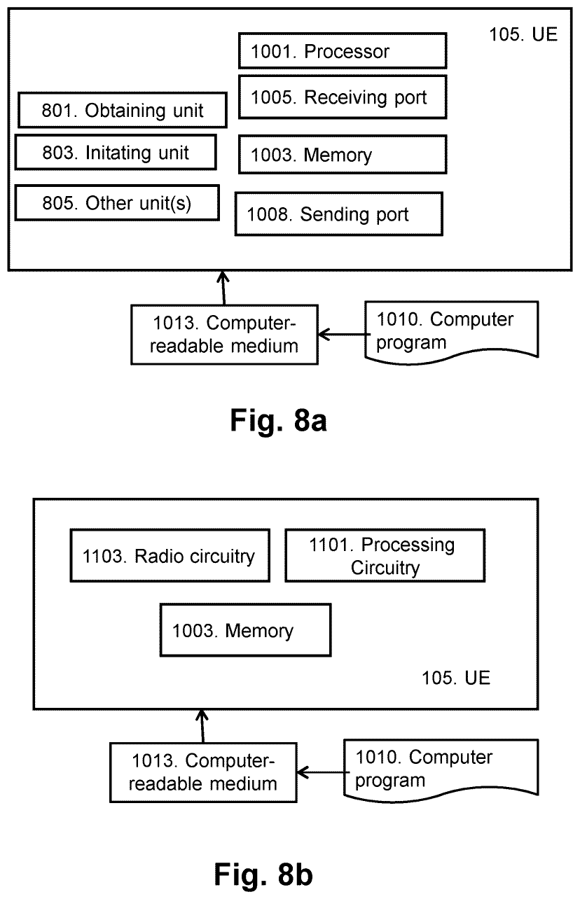

To perform the method steps shown in FIG. 6 for handling CG-SDT resources in a communications system, the UE 105 comprises an arrangement as shown in FIG. 8a and/or FIG. 8b. FIG. 8a and FIG. 8b depict two different examples in panels a) and b), respectively, of the arrangement that the UE 105 may comprise. The UE 105 may comprise the following arrangement depicted in FIG. 8a.

The UE 105 is arranged to, e.g., by means of an obtaining unit 801, obtain a configuration for common CG-SDT resources from a network node 101. The UE 105 which obtains the configuration may be one of multiple UEs 105 that obtains the configuration from the network node 101. The common CG-SDT resources are common to multiple UEs 105. The obtaining unit 801 may also be referred to as an obtaining module, an obtaining means, an obtaining circuit, means for obtaining etc. The obtaining unit 801 may be a processor 1001 of the UE 105 or comprised in the processor 1001 of the UE 105.

The configuration for common CG-SDT resources may be comprised in SI.

The configuration for common CG-SDT resources may be comprised in a RRC Release message.

The configuration for common CG-SDT resources may comprise an indication of whether the common CG-SDT resource is shared or not.

The UE 105 is arranged to, e.g., by means of the obtaining unit 801, obtain from the network node 101, information indicating which SDT resource the UE 105 should use. The SDT resource is the common CG-SDT resources or other MO-SDT resources. The UE 105 which obtains the information may be one of multiple UEs 105 that obtains the information from the network node 101.

The other MO-SDT resources may comprise dedicated CG-SDT resources or RA-SDT resources.

The information indicating if the common CG-SDT resources should be used or if the UE 105 should use other MO-SDT resources may be comprised in a paging message.

The UE 105 is arranged to, e.g., by means of an initiating unit 803, initiate a SDT procedure by using the common CG-SDT resources or the other MO-SDT resources, according to the obtained information. The initiating unit 803 may also be referred to as an initiating module, an initiating means, an initiating circuit, means for initiating etc. The initiating unit 803 may be the processor 1001 of the UE 105 or comprised in the processor 1001 of the UE 105.

The UE 105 may be arranged to, e.g., by means of the obtaining unit 801, obtain, from the network node 101, a configuration for other CG-SDT resources. The UE 105 which obtains the information may be one of multiple UEs 105 that obtains the information from the network node 101.

The UE 105 may be arranged to, e.g., by means of the obtaining unit 801, obtain, information indicating which DMRS resources to use for transmission. The UE may use different DMRS resources than other UEs 105. The UE 105 which obtains the information may be one of multiple UEs 105 that obtains the information from the network node 101.

The UE 105 may be arranged to, e.g., by means of the obtaining unit 801, obtain, from the network node 101, time information indicating how long time the UE 105 can use the common CG-SDT resources. The UE 105 which obtains the information may be one of multiple UEs 105 that obtains the information from the network node 101.

The UE 105 may be arranged to, e.g., by means of the obtaining unit 801, obtain, from the network node 101, information indicating when the UE 105 is allowed to transmit a response to data received in a DL. The UE 105 which obtains the information may be one of multiple UEs 105 that obtains the information from the network node 101.

The UE 105 may be arranged to, e.g., by means of the obtaining unit 801, obtain, from the network node 101, information indicating if TA validation is needed before using the CG-SDT resource. The UE 105 which obtains the information may be one of multiple UEs 105 that obtains the information from the network node 101.

The UE 105 may be arranged to, e.g., by means of the obtaining unit 801, obtain, from the network node 101, information indicating if the CG-SDT resource can be used if no acknowledgement is obtained from the network node 101. The UE 105 which obtains the information may be one of multiple UEs 105 that obtains the information from the network node 101.

The present mechanism for for handling CG-SDT resources in a communications system may be implemented through one or more processors, such as the processor 1001 in the network node arrangement depicted in FIG. 8a and/or 8b, together with computer program code for performing the functions described herein. The processor may be for example a DSP, ASIC processor, FPGA processor or microprocessor. The program code mentioned above may also be provided as a computer program product, for instance in the form of a data carrier carrying computer program code for performing the present disclosure herein when being loaded into the UE 105. One such carrier may be in the form of a CD ROM disc. It is however feasible with other data carriers such as a memory stick. The computer program code can be provided as pure program code on a server and downloaded to the UE 105.

The UE 105 may comprise a memory 1003 comprising one or more memory units. The memory 1003 is arranged to be used to store obtained information, store data, configurations, schedulings, and applications etc. to perform the methods herein when being executed in the UE 105.

The UE 105 may receive information from, e.g., the network node 101, through a receiving port 1005. The receiving port 1005 may be, for example, connected to one or more antennas in UE 105. The UE 105 may receive information from another structure in the communications system 100 through the receiving port 1005. Since the receiving port 1005 may be in communication with the processor 1001, the receiving port 1005 may then send the received information to the processor 1001. The receiving port 1005 may also be configured to receive other information.

The processor 1001 in the UE 105 may be configured to transmit or send information to e.g., network node 101 or another structure in the communications system 100, through a sending port 1008, which may be in communication with the processor 1001, and the memory 1003.

The UE 105 may comprise the obtaining unit 801, the initiating unit 803 and other unit(s) 805 etc.

Those skilled in the art will also appreciate that the obtaining unit 801, the initiating unit 803 and other unit(s) 805 etc. described above may refer to a combination of analogue and digital circuits, and/or one or more processors configured with software and/or firmware, e.g., stored in the memory 1003, that, when executed by the one or more processors such as the processor 1001, perform as described above. One or more of these processors, as well as the other digital hardware, may be comprised in a single ASIC, or several processors and various digital hardware may be distributed among several separate components, whether individually packaged or assembled into a SoC.

The different units 801-805 described above may be implemented as one or more applications running on one or more processors such as the processor 1001.

Thus, the methods described herein for the UE 105 may be respectively implemented by means of a computer program 1010 product, comprising instructions, i.e., software code portions, which, when executed on at least one processor 1001, cause the at least one processor 1001 to carry out the actions described herein, as performed by the UE 105. The computer program 1010 product may be stored on a computer-readable storage medium 1013. The computer-readable storage medium 1013, having stored thereon the computer program 1010, may comprise instructions which, when executed on at least one processor 1001, cause the at least one processor 1001 to carry out the actions described herein, as performed by the UE 105. The computer-readable storage medium 1013 may be a non-transitory computer-readable storage medium, such as a CD ROM disc, or a memory stick. The computer program 1010 product may be stored on a carrier containing the computer program 1010 just described, wherein the carrier is one of an electronic signal, optical signal, radio signal, or the first computer-readable storage medium 508, as described above.

The UE 105 may comprise a communication interface configured to facilitate communications between the UE 105 and other nodes or devices, e.g., the network node 101, or another structure. The interface may comprise a transceiver configured to transmit and receive radio signals over an air interface in accordance with a suitable standard.

The UE 105 may comprise the following arrangement depicted in FIG. 8b. The UE 105 may comprise a processing circuitry 1101, e.g., one or more processors such as the processor 1001, in the UE 105 and the memory 1003. The UE 105 may also comprise a radio circuitry 1103, which may comprise e.g., the receiving port 1005 and the sending port 1008. The processing circuitry 1101 may be configured to, or operable to, perform the method actions according to FIG. 4-6, in a similar manner as that described in relation to FIG. 8a. The radio circuitry 1103 may be configured to set up and maintain at least a wireless connection with the UE 105. Circuitry may be understood herein as a hardware component.

Hence, the present disclosure also relates to the UE 105 operative to operate in the communications system 100. The UE 105 may comprise the processing circuitry 1101 and the memory 1003. The memory 1003 comprises instructions executable by said processing circuitry 1001. The UE 105 is operative to perform the actions described herein in relation to the UE 105, e.g., in FIGS. 4-6.

### Further Extensions and Variations

A telecommunication network may be connected via an intermediate network to a host computer.

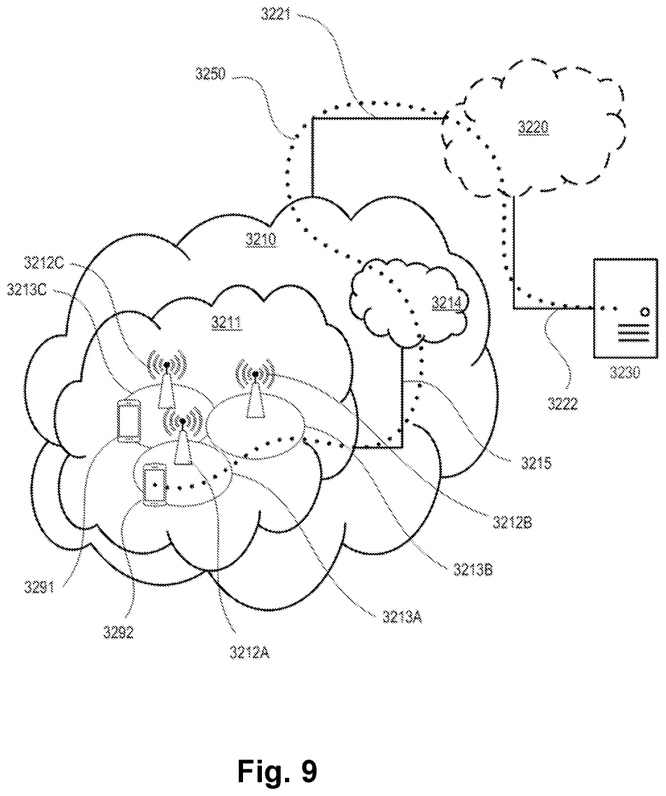

With reference to FIG. 9, a communication system comprises telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 105 may be comprised in the communications system 100. In FIG. 9, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, it is equally applicable to a situation where a sole UE is in the coverage area or where a sole UE is connecting to the corresponding base station 3212. Any of the UEs 3291, 3292 may be considered examples of the UE 105.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 9 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

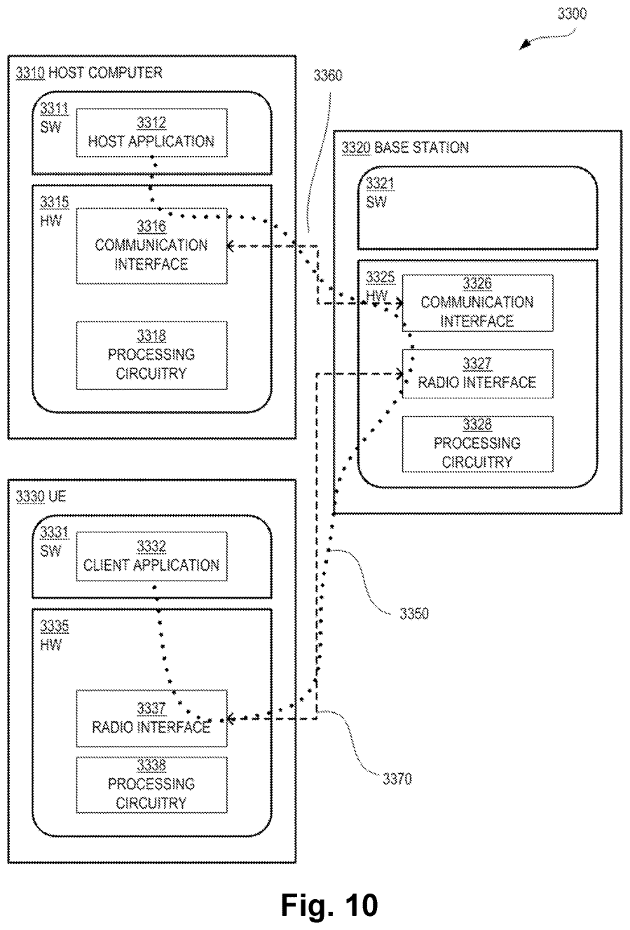

In relation to FIGS. 10-14 which are described next, it may be understood that the base station may be considered an example of the network node 101.

FIG. 10 illustrates an example of host computer communicating via a network node 101 with a UE 105 over a partially wireless connection.

The UE 105 and the network node 101, e.g., a base station and host computer discussed in the preceding paragraphs will now be described with reference to FIG. 10. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 comprises software 3311, which is stored in or accessible by host computer 3310 and executable by processing circuitry 3318. Software 3311 comprises host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the network node 101 exemplified in FIG. 10 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 105, exemplified in FIG. 330 as a UE 3330 located in a coverage area served by base station 3320. Communication interface 3326 may be configured to facilitate connection 3360 to host computer 3310. Connection 3360 may be direct, or it may pass through a core network (not shown in FIG. 330) of the telecommunication system and/or through one or more intermediate networks outside the telecommunication system. Hardware 3325 of base station 3320 comprises processing circuitry 3328, which may comprise one or more programmable processors, application-specific integrated circuits, field programmable gate arrays or combinations of these (not shown) adapted to execute instructions. Base station 3320 has software 3321 stored internally or accessible via an external connection.

Communication system 3300 comprises UE 3330 already referred to. It's hardware 3335 may comprise radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 9, respectively. This is to say, the inner workings of these entities may be as shown in FIG. 10 and independently, the surrounding network topology may be that of FIG. 9.

In FIG. 10, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may take decisions by which it dynamically changes the routing, e.g., onload balancing consideration or reconfiguration of the network.

There may be a wireless connection 3370 between UE 3330 and base station 3320. The present disclosure improves the performance of OTT services provided to UE 3330 using OTT connection 3350, in which wireless connection 3370 forms the last segment. The present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors on which the present disclosure improves. There may be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may comprise message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310′s measurements of throughput, propagation times, latency and the like. The measurements may be implemented in that software 3311 and 3331 causes messages to be transmitted, in particular empty or dummy messages, using OTT connection 3350 while it monitors propagation times, errors etc.

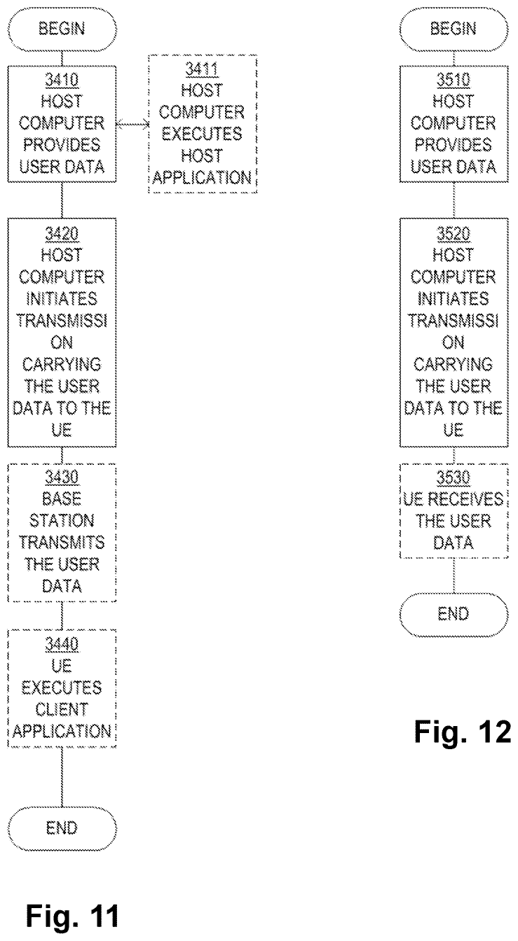

FIG. 11 illustrates an example of methods implemented in a communication system comprising a host computer, a base station and a UE 105. FIG. 11 is a flowchart illustrating a method implemented in a communication system. The communication system comprises a host computer, a base station and a UE 105 which may be those described with reference to FIG. 9 and FIG. 10. For simplicity of the present disclosure, only drawing references to FIG. 11 will be comprised in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits, to the UE 105, the user data which was carried in the transmission that the host computer initiated. In step 3440 (which may also be optional), the UE executes a client application associated with the host application executed by the host computer.

FIG. 12 illustrates methods implemented in a communication system comprising a host computer, a base station and a UE 105. FIG. 12 is a flowchart illustrating a method implemented in a communication system. The communication system comprises a host computer, a base station and a UE 105 which may be those described with reference to FIG. 9 and FIG. 10. For simplicity of the present disclosure, only drawing references to FIG. 12 will be comprised in this section. In step 3510 of the method, the host computer provides user data. In an optional substep (not shown) the host computer provides the user data by executing a host application. In step 3520, the host computer initiates a transmission carrying the user data to the UE 105. The transmission may pass via the base station. In step 3530 (which may be optional), the UE 105 receives the user data carried in the transmission.

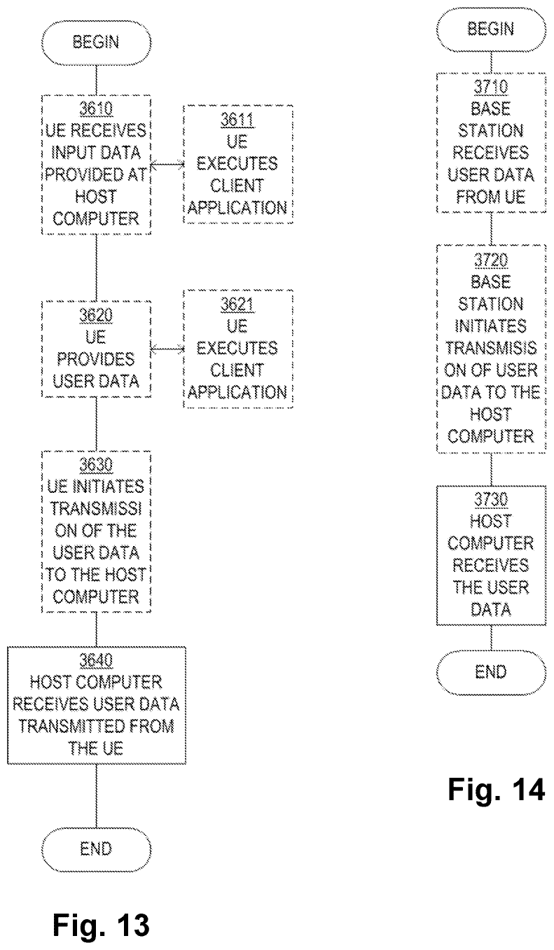

FIG. 13 illustrates methods implemented in a communication system comprising a host computer, a base station and a UE 105. FIG. 13 is a flowchart illustrating a method implemented in a communication system. The communication system comprises a host computer, a network node 101 and a UE 105 which may be those described with reference to FIG. 9 and FIG. 10. For simplicity of the present disclosure, only drawing references to FIG. 13 will be comprised in this section. In step 3610 (which may be optional), the UE 105 receives input data provided by the host computer. Additionally, or alternatively, in step 3620, the UE 105 provides user data. In substep 3621 (which may be optional) of step 3620, the UE 105 provides the user data by executing a client application. In substep 3611 (which may be optional) of step 3610, the UE 105 executes a client application which provides the user data in reaction to the received input data provided by the host computer. In providing the user data, the executed client application may consider user input received from the user. Regardless of the specific way the user data was provided, the UE 105 initiates, in substep 3630 (which may be optional), transmission of the user data to the host computer. In step 3640 of the method, the host computer receives the user data transmitted from the UE 105.

FIG. 14 illustrates methods implemented in a communication system comprising a host computer, a base station and a UE 105. FIG. 14 is a flowchart illustrating a method implemented in a communication system. The communication system comprises a host computer, a base station and a UE 105 which may be those described with reference to FIG. 9 and FIG. 10. For simplicity of the present disclosure, only drawing references to FIG. 14 will be comprised in this section. In step 3710 (which may be optional), the base station receives user data from the UE 105. In step 3720 (which may be optional), the base station initiates transmission of the received user data to the host computer. In step 3730 (which may be optional), the host computer receives the user data carried in the transmission initiated by the base station.

The present disclosure may be summarized as follows:

A base station is configured to communicate with a UE 105. The base station comprises a radio interface and processing circuitry configured to perform one or more of the actions described herein as performed by the network node 101.

A communication system 100 comprises a host computer, and the communication system 100 comprises:
processing circuitry configured to provide user data; and
a communication interface configured to forward the user data to a cellular network for transmission to a UE 105,
wherein the cellular network comprises a network node 101 having a radio interface and processing circuitry, the base station's processing circuitry configured to perform one or more of the actions described herein as performed by the network node 101.

The communication system 100 may comprise the network node 101.

The communication system 100 may comprise the UE 105. The UE 105 is configured to communicate with the network node 101.

The communication system 101, wherein:
the processing circuitry of the host computer is configured to execute a host application, thereby providing the user data; and
the UE 105 comprises processing circuitry configured to execute a client application associated with the host application.

A method implemented in a network node 101. The method comprises one or more of the actions described herein as performed by the network node 101.

A method implemented in a communication system 100 comprising a host computer, a base station and a UE 105, the method comprising:
at the host computer, providing user data; and
at the host computer, initiating a transmission carrying the user data to the UE 105 via a cellular network comprising the network node 101, wherein the network node 101 performs one or more of the actions described herein as performed by the network node 101.

The method may comprise:
at the network node 101, transmitting the user data.

The user data may be provided at the host computer by executing a host application, and the method may comprise:
at the UE 105, executing a client application associated with the host application.

A UE 105 configured to communicate with a network node 101. The UE 105 comprises a radio interface and processing circuitry configured to perform one or more of the actions described herein as performed by the UE 105.

A communication system 100 comprises a host computer. The communication system 100 comprises:
processing circuitry configured to provide user data; and
a communication interface configured to forward user data to a cellular network for transmission to a UE 105,
wherein the UE 105 comprises a radio interface and processing circuitry, the UE's processing circuitry configured to perform one or more of the actions described herein as performed by the UE 105.

The communication system 100 may comprise the UE 105.

The communication system 100, wherein the cellular network comprises a network node 101 configured to communicate with the UE 105.

The communication system 100, wherein:
the processing circuitry of the host computer is configured to execute a host application, thereby providing the user data; and
the UE's processing circuitry is configured to execute a client application associated with the host application.

A method implemented in a UE 105, comprising one or more of the actions described herein as performed by the UE 105.

A method implemented in a communication system 100 comprising a host computer, a network node 101 and a UE 105, the method comprising:
at the host computer, providing user data; and
at the host computer, initiating a transmission carrying the user data to the UE 105 via a cellular network comprising the base station, wherein the UE 105 performs one or more of the actions described herein as performed by the UE 105.

The method may comprise:
at the UE 105, receiving the user data from the network node 101.

A UE 105 configured to communicate with a network node 101, the UE 105 comprising a radio interface and processing circuitry configured to perform one or more of the actions described herein as performed by the UE 105.

A communication system 100 comprising a host computer comprising:
a communication interface configured to receive user data originating from a transmission from a UE 105 to a network node 101,
wherein the UE 105 comprises a radio interface and processing circuitry, the UE's processing circuitry configured to: perform one or more of the actions described herein as performed by the UE 105.

The communication system 100 may comprise the UE 105.

The communication system 100 may comprise the network node 101, wherein the network node 101 comprises a radio interface configured to communicate with the UE 105 and a communication interface configured to forward to the host computer the user data carried by a transmission from the UE 105 to the base station.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 105, comprising one or more of the actions described herein as performed by the UE 105.

The method may comprise:
providing user data; and
forwarding the user data to a host computer via the transmission to the network node 101.

A method implemented in a communication system 100 comprising a host computer, a network node 101 and a UE 105, the method comprising:
at the host computer, receiving user data transmitted to the network node 101 from the UE 105, wherein the UE 105 performs one or more of the actions described herein as performed by the UE 105.

The method may comprise:
at the UE 105, providing the user data to the network node 101.

The method may comprise:
at the UE 105, executing a client application, thereby providing the user data to be transmitted; and
at the host computer, executing a host application associated with the client application.

The method may comprise:
at the UE 105, executing a client application; and
at the UE 105, receiving input data to the client application, the input data being provided at the host computer by executing a host application associated with the client application,
wherein the user data to be transmitted is provided by the client application in response to the input data.

A network node 101 configured to communicate with a UE 105, the network node 101 comprising a radio interface and processing circuitry configured to perform one or more of the actions described herein as performed by the network node 101.

A communication system 100 comprising a host computer comprising a communication interface configured to receive user data originating from a transmission from a UE 105 to a base station, wherein the network node 101 comprises a radio interface and processing circuitry, the base station's processing circuitry configured to perform one or more of the actions described herein as performed by the network node 101.

The communication system 100 may comprise the network node 101.

The communication system 100 may comprise the UE 105, wherein the UE 105 is configured to communicate with the network node 101.

The communication system 100 wherein:
the processing circuitry of the host computer is configured to execute a host application;
the UE 105 is configured to execute a client application associated with the host application, thereby providing the user data to be received by the host computer.

A method implemented in a network node 101, comprising one or more of the actions described herein as performed by any of the network node 101.

A method implemented in a communication system comprising a host computer, a network node 101 and a UE 105, the method comprising:
at the host computer, receiving, from the network node 101, user data originating from a transmission which the base station has received from the UE 105, wherein the UE 105 performs one or more of the actions described herein as performed by the UE 105.

The method may comprise:
at the network node 101, receiving the user data from the UE 105.

The method may comprise:
at the network node 101, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

The present disclosure is not limited to the above. Various alternatives, modifications and equivalents may be used. Therefore, disclosure herein should not be taken as limiting the scope. A feature may be combined with one or more other features.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

The steps of the methods may be performed in another order than the order in which they appear herein.

### ABBREVIATIONS

3GPP 3rd Generation Partnership Project
5G 5th Generation
5GC 5G Core
5GS 5G System
CN Core Network
eNB Evolved Node B, a radio base station in LTE.
gNB 5G Node B, A radio base station in NR.
NG The interface/reference point between the RAN and the CN in 5G/NR.
NG-C The control plane part of NG, between a gNB and an AMF.
NG-RAN Next Generation Radio Access Network
NG-U The user plane part of NG, between a gNB and a UPF.
NR New Radio
nUE NR UE
RAN Radio Access Network
RedCap Reduced Capacity
RRC Radio Resource Control
rUE RedCap UE
TS Technical Specification
UE User Equipment

1. A method performed by a network node (101) for handling Configured Grant-Small Data Transmissions, CG-SDT, resources in a communications system (100), the method comprising:
providing (401, 501) a configuration for common CG-SDT resources to a User Equipment, UE (105), wherein the common CG-SDT resources are common to multiple UEs (105); and
providing (402, 502), to the UE (105), information indicating which SDT resource the UE (105) should use, wherein the SDT resource is the common CG-SDT resources or other Mobile Originated-Small Data Transmissions, MO-SDT, resources.

2. The method according to claim 1, wherein the configuration for common CG-SDT resources is comprised in System Information, SI.

3. The method according to claim 1, wherein the configuration for common CG-SDT resources is comprised in a Radio Resource Control, RRC, Release message.

4. The method according to claim 1, wherein the other MO-SDT resources comprises dedicated CG-SDT resources or Random Access-Small Data Transmission, RA-SDT, resources.

5. The method according to claim 1, wherein the information indicating which SDT resource the UE (105) should use is comprised in a paging message.

6. The method according to claim 1, comprising:
providing (503), to the UE (105), a configuration for other CG-SDT resources.

7. The method according to claim 1, comprising:
providing (504), to the UE (105), information indicating which Demodulation Reference Signal, DMRS, resources to use for transmission, wherein the UE (105) should use different DMRS resources than other UEs (105); and
obtaining (505) transmissions from multiple UEs for (105) the same time and frequency allocation, wherein the transmissions from multiple UEs (105) are distinguishable by the network node (101) by that they use different DMRS resources.

8. The method according to claim 1, wherein the configuration for common CG-SDT resources comprises an indication of whether the common CG-SDT resource is shared or not.

9. The method according to claim 1, comprising:
providing (506), to the UE (105), time information indicating how long time the UE (105) can use the common CG-SDT resources.

10. The method according to claim 1, comprising:
providing (507), to the UE (105), information indicating when the UE (105) is allowed to transmit a response to data received in a downlink, DL.

11. The method according to claim 1, comprising:
grouping (508) two or more UEs (105) based on their distance from the network node (101); and
allocating (509) the common CG-SDT resource to the UEs (101) in the group,
wherein the configuration for the common CG-SDT resources is provided to all UEs (101) in the group.

12. The method according to claim 1, comprising:
providing (510), to the UE (105), information indicating if Timing Advance, TA, validation is needed before using the CG-SDT resource.

13. The method according to claim 1, comprising:
providing (510), to the UE (105), information indicating if the CG-SDT resource can be used if no acknowledgement is obtained from the network node (101).

14. A method performed by a User Equipment, UE, (105) for handling Configured Grant-Small Data Transmissions, CG-SDT, resources in a communications system (100), the method comprising:
obtaining (401, 601) a configuration for common CG-SDT resources from a network node (101), wherein the common CG-SDT resources are common to multiple UEs (105); and
obtaining (402, 602), from the network node (101), information indicating which SDT resource the UE (105) should use, wherein the SDT resource is the common CG-SDT resources or other Mobile Originated-Small Data Transmission, MO-SDT, resources; and
initiating (403, 603) a SDT procedure by using the common CG-SDT resources or the other MO-SDT resources, according to the obtained information.

15. The method according to claim 14, wherein the configuration for common CG-SDT resources is comprised in System Information, SI.

16. The method according to claim 14, wherein the configuration for common CG-SDT resources is comprised in a Radio Resource Control, RRC, Release message.

17. The method according to claim 14, wherein the other MO-SDT resources comprises dedicated CG-SDT resources or Random Access-Small Data Transmission, RA-SDT, resources.

18. The method according to claim 14, wherein the information indicating which SDT resource the UE (105) should use is comprised in a paging message.

19. The method according to claim 14, comprising:
obtaining (604), from the network node (101), a configuration for other CG-SDT resources.

20-25. (canceled)

26. A network node (101) for handling Configured Grant-Small Data Transmissions, CG-SDT, resources, the network node (101) being arranged to perform a method according to claim 1.

27-31. (canceled)
